(19) United States
(12) Patent Application Publication
(10) Pub. No.: US 2013/0003180 A1
(43) Pub. Date: Jan. 3, 2013

(54) FILTER HAVING METAMATERIAL STRUCTURE AND MANUFACTURING METHOD THEREOF

(75) Inventors: Choon Gi Choi, Daejeon (KR); Muhan Choi, Daejeon (KR)

(73) Assignee: Electronics and Telecommunications Research Institute, Daejeon (KR)

(21) Appl. No.: 13/431,055

(22) Filed: Mar. 27, 2012

(30) Foreign Application Priority Data
Jun. 28, 2011 (KR) 10-2011-0062934

(51) Int. Cl. G02B 5/28; B29D 11/00

(52) U.S. Cl. 359/585; 359/589; 264/1.7

(57) ABSTRACT

Provided are a filter having a metamaterial structure and a method of manufacturing the filter. The filter includes a first dielectric layer, a first fishnet pattern having one or more first holes partially exposing the first dielectric layer, a second dielectric layer covering the first fishnet pattern and the first dielectric layer, a plurality of reverse patterns having the same shape as those of the first holes, and disposed on the second dielectric layer over the first holes, and a third dielectric layer covering the reverse patterns and the second dielectric layer.

### CROSS-REFERENCE TO RELATED APPLICATIONS

This U.S. non-provisional patent application claims priority under 35 U.S.C. §119 of Korean Patent Application No. 10-2011-0062934, filed on Jun. 28, 2011, the entire contents of which are hereby incorporated by reference.

### BACKGROUND OF THE INVENTION

The present invention disclosed herein relates to a filter and a method of manufacturing the filter, and more particularly, to a metamaterial having a metamaterial structure and a method of manufacturing the metamaterial.

Metamaterials may include artificial materials that gain their properties from a periodically arrayed artificial structure rather than a composition of atoms and molecules. Such an artificial structure in a metamaterial may be significantly greater than a molecule. Thus, the path of an electromagnetic wave passing through a metamaterial may be determined using the macroscopic set of Maxwell's equations. However, an artificial structure in a metamaterial may be much smaller than the working wavelength of electromagnetic wave. Thus, a metamaterial may include structures having a shape and size such that macroscopic material response characteristics are determined according to spectrum components in a near-field region. Such metamaterials are composed of traditional materials such as conductors and semiconductors, and arrays of repeating micro patterns so as to vary the collective characteristics thereof. Accordingly, electromagnetic waves can be handled using metamaterials in a unique manner that cannot be applied to typical materials.

Sensors for sensing the presence or concentration of gas may include an electrochemistry sensor and an optical sensor. Optical sensors may be superior to electrochemistry sensors in terms of accuracy, sensing speed, and durability. Such an optical sensor may include a detector and a narrow bandpass filter for passing electromagnetic waves in only a specific wavelength range. In many cases, the performance and sensitivity of an optical sensor depend on its narrow bandpass filter. A narrow bandpass filter may include a multi-layered thin film filter in which different types of dielectric layers are repeatedly stacked. When a stacking process is performed to form a multi-layered thin film filter of a narrow bandpass filter, it may be difficult to precisely control the thickness of each dielectric layer with consistency, which may decrease productivity.

### SUMMARY OF THE INVENTION

The present invention provides a filter having a metamaterial structure and a method of manufacturing the filter, which can increase or maximize productivity.

The present invention also provides a filter having a flexible metamaterial structure and a method of manufacturing the filter.

Embodiments of the present invention provide filters including: a first dielectric layer; a first fishnet pattern having one or more first holes partially exposing the first dielectric layer; a second dielectric layer covering the first fishnet pattern and the first dielectric layer; a plurality of reverse patterns having the same shape as those of the first holes, and disposed on the second dielectric layer over the first holes; and a third dielectric layer covering the reverse patterns and the second dielectric layer.

In some embodiments, the first holes and the reverse patterns may have the same size.

In other embodiments, the first holes and the reverse patterns may have at least one of a squarel shape and a circular shape in common.

In still other embodiments, the first fishnet pattern and the reverse image pattern may include at least one of gold, chrome, silver, aluminum, copper, and nickel.

In even other embodiments, the first to third dielectric layers may include polyimide.

In yet other embodiments, the first to third dielectric layers may include a metallic or inorganic dielectric formed of at least one of an aluminum oxide film, a silicon oxide film, a titanium oxide film, and a magnesium fluorine film.

In further embodiments, the filters may further include: a second fishnet pattern having second holes exposing the third dielectric layer disposed over the first holes and the reverse patterns; and a fourth dielectric layer covering the second fishnet pattern and the third dielectric layer.

In still further embodiments, the second holes may be aligned with the first holes and the reverse patterns.

In even further embodiments, the second and third dielectric layers may have the same thickness.

In other embodiments of the present invention, methods of manufacturing a filter include: forming a first dielectric layer on a substrate; forming a first fishnet pattern having one or more first holes partially exposing the first dielectric layer; forming a second dielectric layer covering the first fishnet pattern; forming reverse patterns having the same shape as those of the first holes, and disposed on the second dielectric layer; covering the reverse patterns and the second dielectric layer with a third dielectric layer; and removing the substrate from the first dielectric layer.

In some embodiments, the methods may further include: forming a second fishnet pattern having second holes exposing the third dielectric layer disposed over the first holes and the reverse patterns; and forming a fourth dielectric layer covering the second fishnet pattern and the third dielectric layer.

In other embodiments, the first and second fishnet patterns and the reverse patterns may be formed through an inkjet printing process.

In still other embodiments, the first to fourth dielectric layers may be formed through a spin coating process.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a perspective view illustrating a filter according to an embodiment of the present invention;

FIG. 2 is a plan view illustrating the filter of FIG. 1;

FIG. 3 is a graph illustrating transmission coefficient versus frequency of terahertz electromagnetic waves according to another embodiment of the present invention;

FIG. 4 is a graph illustrating transmission coefficient varied with thickness of a second dielectric layer according to another embodiment of the present invention;

FIG. 5 is a perspective view illustrating a filter according to another embodiment of the present invention; and

FIGS. 6 to 13 are perspective views illustrating a filter manufacturing method according to an embodiment of the present invention.

### DETAILED DESCRIPTION OF PREFERRED EMBODIMENTS

Hereinafter, embodiments of the present invention will now be described in detail with reference to the accompanying drawings. The present invention and implementation methods thereof will be clarified through the following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Like reference numerals refer to like elements throughout.

In the following description, the technical terms are used only for explaining exemplary embodiments while not limiting the present invention. The terms of a singular form may include plural forms unless referred to the contrary. The meaning of ‘comprises’ and/or ‘comprising’ specifies a property, a region, a fixed number, a step, a process, an element and/or a component but does not exclude other properties, regions, fixed numbers, steps, processes, elements and/or components. Since exemplary embodiments are provided below, the order of the reference numerals given in the description is not limited thereto.

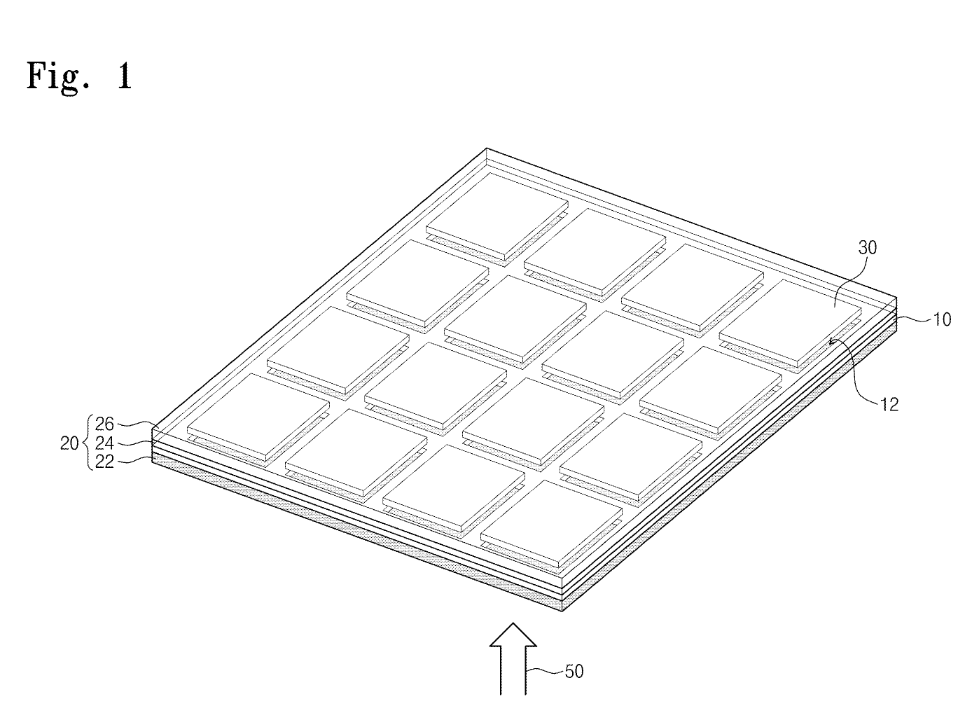

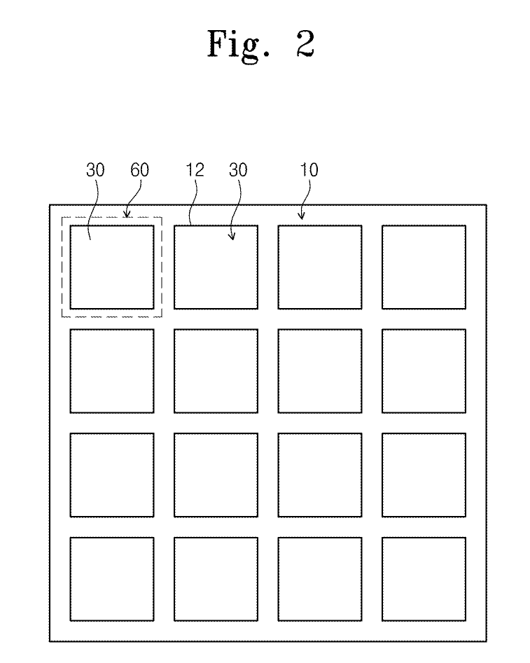

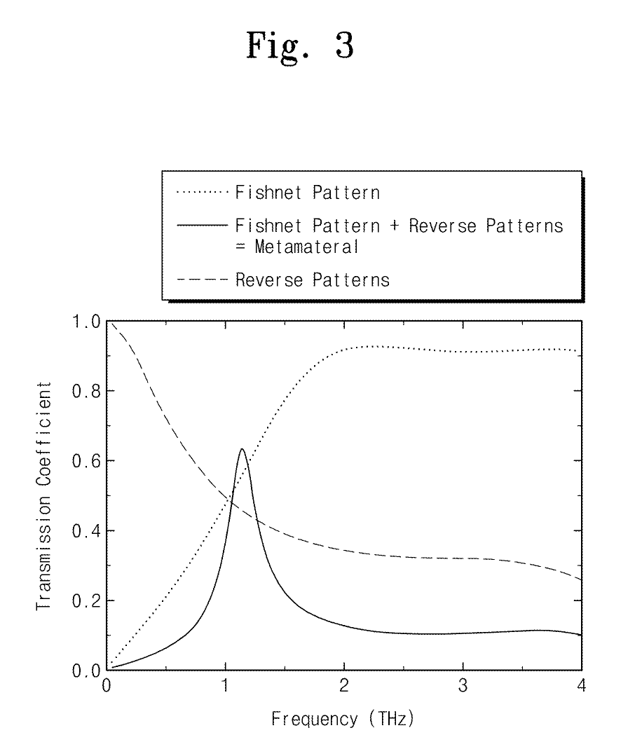

FIG. 1 is a perspective view illustrating a filter according to an embodiment of the inventive concept. FIG. 2 is a plan view illustrating the filter of FIG. 1. FIG. 3 is a graph illustrating transmission coefficient versus frequency of terahertz electromagnetic waves according to the current embodiment.

Referring to FIGS. 1 to 3, a filter according to the current embodiment may include: a first fishnet pattern 10 having first holes 12; a plurality of reverse patterns 30 having the same shape as those of the first holes 12; and a second dielectric layer 24 between the first fishnet pattern 10 and the plurality of the reverse patterns 30. First and third dielectric layers 22 and 26 may cover the first fishnet pattern 10 and the reverse patterns 30. The first fishnet pattern 10 and the reverse patterns 30 may include a conductive metal. One of the first and third dielectric layers 22 and 26 may first receive an electromagnetic wave 50. The electromagnetic wave 50 may have a terahertz frequency. The first fishnet pattern 10 may correspond to a high-pass frequency selective surface that has a transmission coefficient of about 0.5 or greater when the electromagnetic wave 50 has a frequency of about 1 terahertz (THz) or higher. The reverse patterns 30 may correspond to a low-pass frequency selective surface that has a transmission coefficient of about 0.5 or greater when the electromagnetic wave 50 has a frequency of about 1 THz or lower. The transmission coefficient has a range from 0 to 1.

The filter according to the current embodiment may have a metamaterial structure that has a transmission coefficient of about 0.6 or greater when the electromagnetic wave 50 has a frequency of about 1.2 THz. The horizontal axis of FIG. 3 denotes terahertz frequency of the electromagnetic wave 50, and the vertical axis thereof denotes transmission coefficient.

Dielectric layers 20 may include a polymer such as polyimide having excellent transparency and flexibility. Alternatively, the dielectric layers 20 may include a metallic or inorganic dielectric formed of at least one of an aluminum oxide film, a silicon oxide film, a titanium oxide film, and a magnesium fluorine film. The second dielectric layer 24 may determine a distance between the first fishnet pattern 10 and the plurality of the reverse patterns 30.

The first fishnet pattern 10 and the reverse patterns 30 may have a thickness of about 100 nm. The first fishnet pattern 10 and the reverse patterns 30 may include a metal layer formed of at least one of gold, chrome, silver, aluminum, copper, and nickel. The reverse patterns 30 and the first holes 12 of the first fishnet pattern 10 may have at least one of a squarel shape and a circular shape in common. The first holes 12 and the reverse patterns 30 may have the same size.

Each of unit cells 60 may include a ring of the first fishnet pattern 10, and the reverse image pattern 30 over the first hole 12 within the ring. A transmission frequency of the electromagnetic wave 50 may be determined according to the area of the unit cells 60 and the distance between the first fishnet pattern 10 and the plurality of the reverse patterns 30. For example, the unit cells 60 may have an area of about 40×40 μm². The first fishnet pattern 10 may be spaced about 5 μm from the reverse patterns 30 by the second dielectric layer 24.

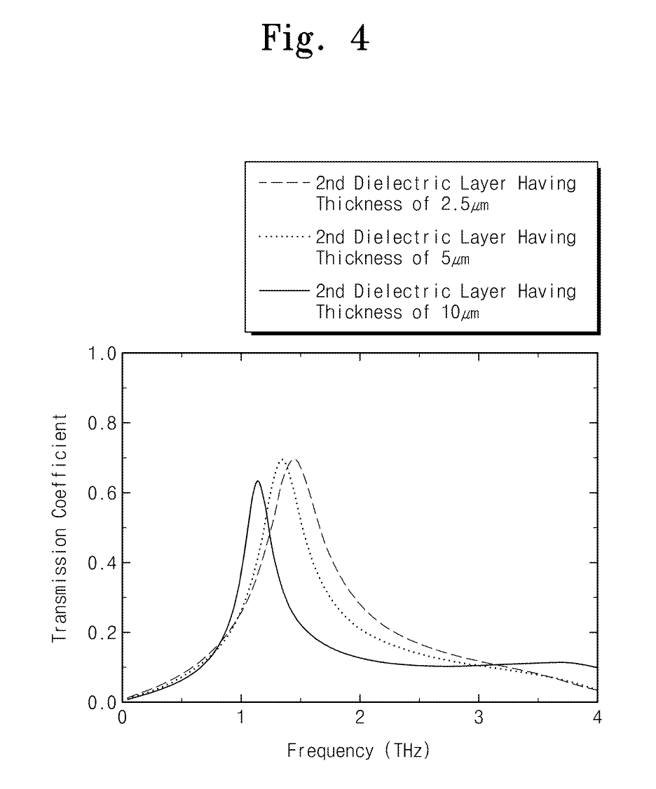

FIG. 4 is a graph illustrating transmission coefficient varied with thickness of a second dielectric layer according to the current embodiment.

Referring to FIGS. 1 and 4, as the thickness of the second dielectric layer 24 decreases, a transmission frequency and a transmission frequency band width for filtering may increase. The horizontal axis of FIG. 4 denotes terahertz frequency of the electromagnetic wave 50, and the vertical axis thereof denotes transmission coefficient. For example, when the second dielectric layer 24 has a thickness of about 10 μm, the filter according to the current embodiment may pass an electromagnetic wave having a frequency of about 1.15 THz. When the second dielectric layer 24 has a thickness of about 5 μm, the filter may pass an electromagnetic wave having a frequency of about 1.3 THz. When the second dielectric layer 24 has a thickness of about 2.5 μm, the filter may pass an electromagnetic wave having a frequency of about 1.4 THz. Thus, as the distance between the first fishnet pattern 10 and the reverse patterns 30 decreases, the transmission frequency and the transmission coefficient may increase.

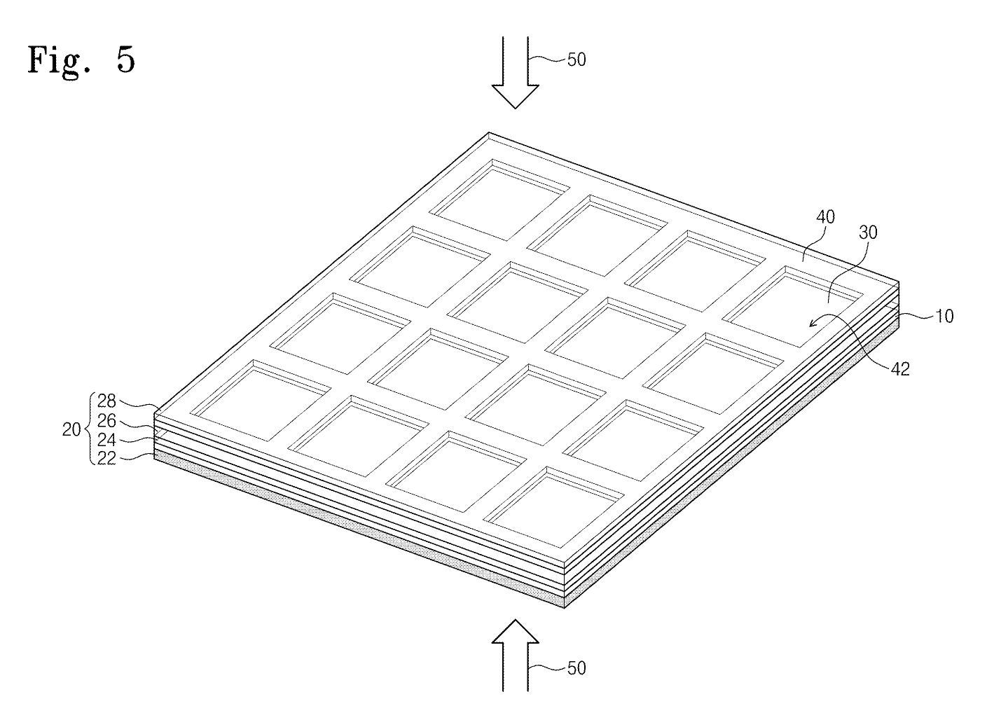

FIG. 5 is a perspective view illustrating a filter according to an embodiment of the inventive concept.

Referring to FIG. 5, a filter according to the current embodiment may include: a second fishnet pattern 40 having second holes 42 aligned with the reverse patterns 30, and disposed on the third dielectric layer 26; and a fourth dielectric layer 28 covering the second fishnet pattern 40 and the third dielectric layer 26. The fourth dielectric layer 28 may include polyimide, a metal dielectric, or an inorganic dielectric, like the first, second, and third dielectric layers 22, 24, and 26. The second and third dielectric layers 24 and 26 may have the same thickness. The first and second holes 12 and 42 may have the same size. The second holes 42 may be aligned with the first holes 12 and the reverse patterns 30. The first and second fishnet patterns 10 and 40 may have the same thickness.

The first and second fishnet patterns 10 and 40 and the reverse patterns 30 may include the same metal layer. The first fishnet pattern 10 may be symmetrical to the second fishnet pattern 40 with respect to the reverse patterns 30. The third dielectric layer 26 may determine a distance between the second fishnet pattern 40 and the plurality of the reverse patterns 30. The second and third dielectric layers 24 and 26 may have the same thickness. The electromagnetic wave 50 may be incident to one of the first and fourth dielectric layers 22 and 28.

Thus, the first and second fishnet patterns 10 and 40 are disposed at the upper and lower sides of the reverse patterns 30, so that the filter according to the current embodiment has a symmetric structure.

A method of manufacturing the filter according to the previous embodiments will now be described with reference to the accompanying drawings.

FIGS. 6 to 13 are perspective views illustrating a filter manufacturing method according to an embodiment of the inventive concept.

Referring to FIG. 6, the first dielectric layer 22 is formed on a substrate 21. The substrate 21 may include a silicon wafer. The first dielectric layer 22 may include polyimide through a spin coating process. Alternatively, the first dielectric layer 22 may include a metallic or inorganic dielectric formed of at least one of an aluminum oxide film, a silicon oxide film, a titanium oxide film, and a magnesium fluorine film, through a chemical vapor deposition process or a physical vapor deposition process.

Referring to FIG. 7, the first fishnet pattern 10 is formed on the first dielectric layer 22. To this end, an inkjet printing process may be performed to form a first metal layer. Alternatively, a liftoff process may be performed on a first metal layer formed on a first photoresist pattern (not shown) in order to form the first fishnet pattern 10. In this case, the first photoresist pattern may be performed through a photolithography process. The first metal layer may include at least one of gold, chrome, silver, aluminum, copper, and nickel through an electron beam deposition process.

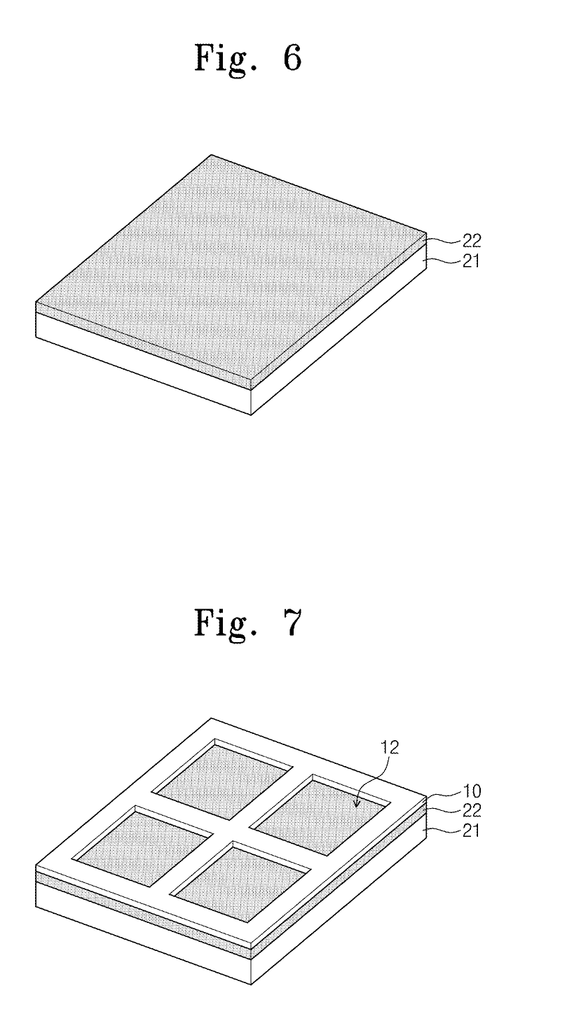

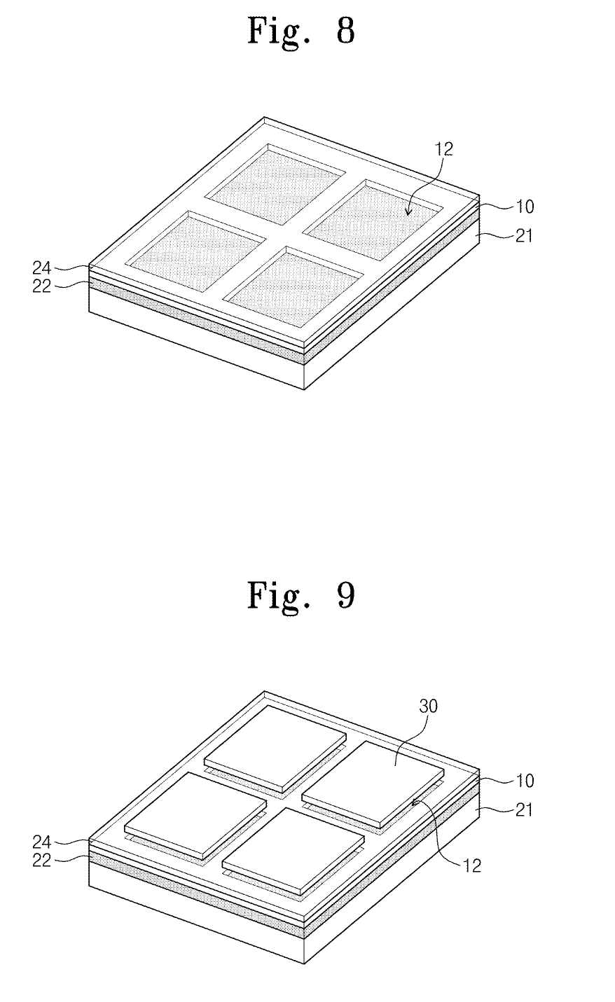

Referring to FIG. 8, the second dielectric layer 24 is formed over the first fishnet pattern 10 and the first dielectric layer 22. The second dielectric layer 24 may include a polymer such as polyimide through a spin coating process. The second dielectric layer 24 has a thickness that may be varied with the number of rotations of the substrate 21 in the spin coating process. Alternatively, the second dielectric layer 24 may include a metallic or inorganic dielectric through a chemical vapor deposition process or a physical vapor deposition process. In this case, the second dielectric layer 24 may have a thickness that may be varied with deposition speed in the chemical vapor deposition process or the physical vapor deposition process.

Referring to FIG. 9, the reverse patterns 30 are formed on the second dielectric layer 24 over the first holes 12. The reverse patterns 30 may be formed using an inkjet printing process.

Alternatively, the reverse patterns 30 may be formed by performing a liftoff process on a second metal layer formed on a photoresist pattern. In this case, the second metal layer may be formed through an electron beam deposition process. The second metal layer may include at least one of gold, chrome, silver, aluminum, copper, and nickel. The first fishnet pattern 10 and the plurality of the reverse patterns 30 may be alternately formed with the first and second dielectric layers 22 and 24. The distance between the first fishnet pattern 10 and the reverse patterns 30 may be determined by the second dielectric layer 24. Thus, the distance between the first fishnet pattern 10 and the reverse patterns 30 may be easily adjusted through a process of forming the second dielectric layer 24. Accordingly, the filter manufacturing method according to the current embodiment can increase or maximize productivity.

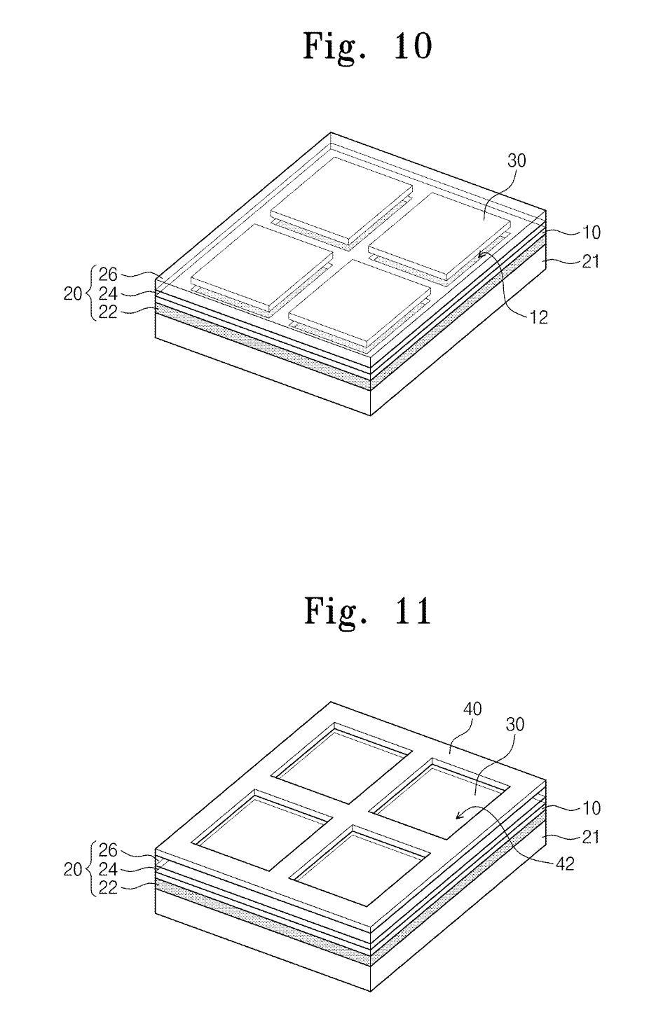

Referring to FIGS. 10 and 13, the third dielectric layer 26 is formed over the reverse patterns 30 and the second dielectric layer 24. The third dielectric layer 26 may be formed through a spin coating process, a chemical vapor deposition process, or a physical vapor deposition process. The second and third dielectric layers 24 and 26 may have the same thickness. After the third dielectric layer 26 is formed, the first dielectric layer 22 may be removed from the substrate 21. The substrate 21 may be crushed. Thus, the filter manufacturing method according to the current embodiment may include a process of removing the first dielectric layer 22 after the third dielectric layer 26 covering the reverse patterns 30 is formed.

Referring to FIG. 11, the second fishnet pattern 40 having the second holes 42 is formed. The second holes 42 expose the third dielectric layer 26 disposed over the first holes 12 and the reverse patterns 30. Like the first fishnet pattern 10, the second fishnet pattern 40 may include a third metal layer through an inkjet printing process or a liftoff process. The third metal layer may be the same as the first metal layer. The first and second holes 12 and 42 may have the same size. The second holes 42 may be aligned with the first holes 12 and the reverse patterns 30. The third dielectric layer 26 may determine the distance between the second fishnet pattern 40 and the reverse patterns 30. The second and third dielectric layers 24 and 26 may have the same thickness.

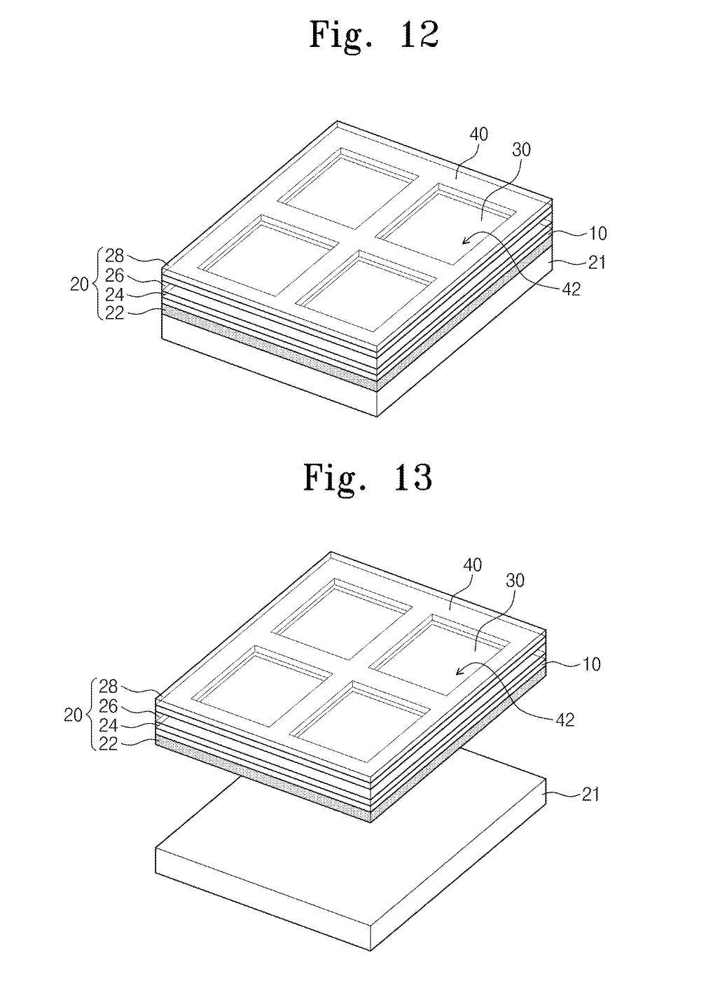

Referring to FIG. 12, the fourth dielectric layer 28 is formed over the second fishnet pattern 40 and the third dielectric layer 26. The fourth dielectric layer 28 may be formed through a spin coating process, a chemical vapor deposition process, or a physical vapor deposition process.

Referring to FIGS. 5 and 13, the substrate 21 is removed from the first dielectric layer 22. The dielectric layers 20 may have excellent flexibility. The first and second fishnet patterns 10 and 40, the reverse patterns 30, and the dielectric layers 20 may have a metamaterial structure. The distance between the first fishnet pattern 10 and the reverse patterns 30 may be easily adjusted through the process of forming the second dielectric layer 24, and the distance between the second fishnet pattern 40 and the reverse patterns 30 may be easily adjusted through a process of forming the third dielectric layer 26.

Accordingly, the filter manufacturing method according to the current embodiment can increase or maximize productivity.

According to the above-described embodiments, a fishnet pattern may be spaced apart from reverse patterns by a second dielectric layer. A distance between the fishnet pattern and the reverse patterns may correspond to a thickness of the second dielectric layer. Dielectric layers, fishnet patterns, and reverse patterns may have a metamaterial structure. The dielectric layers may include polyimide having excellent flexibility. Accordingly, a filter according to the embodiments may have a flexible metamaterial structure. Since only both a size adjustment of the fishnet pattern and a thickness adjustment of the second dielectric layer between the fishnet pattern and the reverse patterns are required to control operation characteristics of a filter according to the embodiments, a filter manufacturing method according to the embodiments can increase or maximize productivity.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A filter comprising:
a first dielectric layer;
a first fishnet pattern having one or more first holes partially exposing the first dielectric layer;
a second dielectric layer covering the first fishnet pattern and the first dielectric layer;
a plurality of reverse patterns having the same shape as those of the first holes, and disposed on the second dielectric layer over the first holes; and
a third dielectric layer covering the reverse patterns and the second dielectric layer.

2. The filter of claim 1, wherein the first holes and the reverse patterns have the same size.

3. The filter of claim 2, wherein the first holes and the reverse patterns have at least one of a square shape and a circular shape in common.

4. The filter of claim 3, wherein the first fishnet pattern and the reverse image pattern comprises at least one of gold, chrome, silver, aluminum, copper, and nickel.

5. The filter of claim 4, wherein the first to third dielectric layers comprise polyimide.

6. The filter of claim 4, wherein the first to third dielectric layers comprise a metallic or inorganic dielectric formed of at least one of an aluminum oxide film, a silicon oxide film, a titanium oxide film, and a magnesium fluorine film.

7. The filter of claim 4, further comprising:
a second fishnet pattern having second holes exposing the third dielectric layer disposed over the first holes and the reverse patterns; and
a fourth dielectric layer covering the second fishnet pattern and the third dielectric layer.

8. The filter of claim 7, wherein the second holes are aligned with the first holes and the reverse patterns.

9. The filter of claim 8, wherein the second and third dielectric layers have the same thickness.

10. A method of manufacturing a filter, the method comprising:
forming a first dielectric layer on a substrate;
forming a first fishnet pattern having one or more first holes partially exposing the first dielectric layer;
forming a second dielectric layer covering the first fishnet pattern;
forming reverse patterns on the second dielectric layer, the reverse patterns having the same shape as those of the first holes;
covering the reverse patterns and the second dielectric layer with a third dielectric layer; and
removing the substrate from the first dielectric layer.

11. The method of claim 10, further comprising:
forming a second fishnet pattern having second holes exposing the third dielectric layer disposed over the first holes and the reverse patterns; and
forming a fourth dielectric layer covering the second fishnet pattern and the third dielectric layer.

12. The method of claim 11, wherein the first and second fishnet patterns and the reverse patterns are formed through an inkjet printing process.

13. The method of claim 12, wherein the first to fourth dielectric layers are formed through a spin coating process.
